(19) United States
(12) Patent Application Publication
(10) Pub. No.: US 2007/0112811 A1
(43) Pub. Date: May 17, 2007

(54) Architecture for scalable video coding applications

(75) Inventors: Guo Bin Shen, Beijing (CN); Feng Wu, Beijing (CN); Shipeng Li, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/254,843

(22) Filed: Oct. 20, 2005

(51) Int. Cl. G06F 7/00

(52) U.S. Cl. 707/101

(57) ABSTRACT

An architecture provides adaptive access to scalable media codestreams. Minimum coding units from the codestream to facilitate presentation of the media content at a selected access level are collected in packettes. The data needed for the packettes are identified and assembled by a peering subsystem or peer layer that supplements a conventional architecture in a sending system. The packettes are communicated to one or more receiving systems, such as by collecting the packeftes into transport packets recognized by conventional architecture. The peering subsystem or peering layer of a receiving system unpacks the packeftes needed to support the desired access level to the media content. The peer subsystems or peer layers communicate between systems to effect changes in the packettes provided to adapt access levels or avoid waste of network resources. The architecture supports applications including multiple access level streaming of media content, device roaming, and time-dependent access level shifting.

### BACKGROUND

People use many different types of devices to access services over the Internet and other networks. Increasingly, people use these devices to access motion video from entertainment sources, news services, and other providers.

FIG. 1 illustrates a number of different digital devices 102-108 that may be used to access media content. Generally, media content is accessed by devices 102-108 from servers 110 and 112 via a network 114, such as a local area network or a wide area network, such as the Internet. The personal computer 102 may be associated with a large, high-resolution display. Alternatively, as shown in FIG. 1, the personal computer 102 may be a media center computer associated with a high resolution television display or video monitor 122, or a video projector (not shown). Thus, the user of the personal computer 102 is likely to want video content displayed at its highest resolution to take advantage of the capabilities of the video monitor 122.

On the other hand, the portable display 124 of the portable computer 104 may not provide resolution comparable to that of the video monitor 122 of the personal computer 102. Alternatively, even if the portable display 124 does support high resolution graphics, the portable computer 104 may be coupled with the network 114 via a lower bandwidth connection. As a result, the user may have to sacrifice resolution in exchange for being able to access the media content without having to wait an intolerably long time to receive the media content and to be able to play the media content continuously, and without pauses or delays.

In addition to the personal computer 102 and the portable computer 104, handheld devices 106 and 108 also are used to access Internet services. For example, a personal digital assistant 106 includes a touchscreen display 126, measuring a few inches on each side, that permits access to video content, albeit it at only a portion of the resolution available with the personal computer 102 and the portable computer 104. Even a smaller device, such as wireless telephone 108, includes a phone display 128 usable to access media services and present video content to a user. Users may also access media content using gaming systems and other portable and non-portable devices.

Historically, the broad range of devices 102-108 seeking to access media content on servers 110 and 112 has posed a problem for content providers. More specifically, because of the wide range of displays 122-128 used by devices 102-108, media content providers have had to make media content available in different formats. For example, high resolution video content had to be made available to users with high resolution video monitors 122, while lower resolution video content had to be made available to users using devices with lower resolution displays or via slower network connections. Conventionally, content providers maintained the video content in multiple resolution formats selectable by a user. Alternatively, the format might be determined automatically based on information available to the host about the device or the connection used to access the media content.

The problem of servers 110-112 having to maintain and selectively communicate multiple different video content formats is addressed by scalable image formats. For one example, the Joint Photographic Experts Group 2000 (“JPEG 2000”) format specifies a codestream that is scalable not only in resolution, but for each of a number of different access types including tile, layer, quality component, precinct, bit rate, and peak signal to noise ratio. The codestream is scalable at a number of levels within each of these access types. A single codestream can be accessed by different devices to present images or video adapted to levels each of the devices is configured to support for each access type. Thus, one image codestream can be stored and provided to any device supporting the scalable codestream.

FIGS. 2A-2E are a series of diagrams illustrating the nature of video frames presented in a JPEG 2000 codestream. FIG. 2A shows a frame 200 as a user views it: image 200 is comprised of an array of elements 202. However, the actual structure of the scalable codestream is not so simply organized.

FIG. 2B is an array 210 of differently sized data blocks 212, representing how different resolution levels are represented in the codestream. As a function of discrete wavelet transformation, accessing different resolution levels involves accessing different blocks of data 212 in the codestream. As shown in FIG. 2C, to access a lowest supported resolution level, only a first data block 222 of array 220 is accessed. As shown in FIG. 2D, to access a next highest resolution level, data block 222 and a series of three adjoining second data blocks 232 are accessed. To access a next highest resolution level, as shown in FIG. 2E, first data block 222, second data blocks 232, and a series of adjoining third data blocks 242 all must be accessed. Adjoining groups of data blocks are accessed until the highest available image resolution is reached. Thus, data blocks used in presenting higher levels of resolution encompasses data are used in presenting lower levels of resolution.

With a scalable codestream, of which the JPEG 2000 codestream described above is just one example, all the devices 102, 104, 106 and 108, can access the same codestream and present media content on their associated displays 122, 124, 126, and 128, respectively. Thus, differently enabled devices can present media content at access levels as high or as low as users' hardware systems, available bandwidth, and preferences allow.

Scalable codestreams allow for the possibility of differently enabled devices accessing the codestreams at various levels, but sending and receiving the full codestreams may not be very efficient. For example, when a receiving system requests access to media content, a sending device may deliver the entirety of the codestream so that the receiving system can access the media content at the highest access levels it supports. However, if the user uses a device with a low resolution display or has only a low-bandwidth network connection, and thus will access the codestream at lower access levels, transmission of the entire codestream may be wasteful. On the other hand, if the user selects a non-scalable codestream to save downloading time, but then wishes to access the codestream at higher access levels, the user will have to reinitiate access to the codestream at the higher access level, and acquire the codestream all over again.

### SUMMARY

An architecture provides adaptive access to scalable media codestreams. Minimum coding units from the codestream to facilitate presentation of the media content at a selected access level are collected in packettes. The data needed for the packettes are identified and assembled by a peering subsystem or peer layer that supplements a conventional architecture in a sending system. The packettes are communicated to one or more receiving systems, such as by collecting the packettes into transport packets recognized by conventional architecture. The peering subsystem or peering layer of a receiving system unpacks the packettes needed to support the desired access level to the media content. The peer subsystems or peer layers communicate between systems to effect changes in the packettes provided to adapt access levels or avoid waste of network resources. The architecture supports applications including multiple access level streaming of media content, device roaming, and time-dependent access level shifting.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a three-digit reference number and the two left-most digits of a four-digit reference number identify the figure in which the reference number first appears,. The use of the same reference numbers in different figures indicates similar or identical items.

FIG. 1 (Prior Art) represents a network in which different devices with different display capabilities used to access content on the same servers.

FIGS. 2A-2E (Prior Art) illustrate data blocks used in presenting image content at different access levels.

FIG. 3 is a block diagram of two systems using an embodiment of an architecture to adaptively send and receive media content.

FIG. 4 is a block diagram of a computer network protocol adapted to include a peer layer.

FIG. 5 is a block diagram of a packette used to exchange one or more minimum coding blocks of data used by a scalable codestream.

FIG. 6 is a block diagram of subsystems of a sending system and a receiving system according to an architecture for adaptively exchanging scalable codestreams.

FIG. 7 is a flow diagram of a process for both adaptively sending and adaptively receiving the content of a scalable codestream.

FIG. 8 is a network in which multiple receiving systems with different capabilities adaptively receive the content of a scalable codestream.

FIG. 9 is a flow diagram of a mode of adaptively receiving the content of a scalable codestream used by each of the systems of FIG. 8.

FIG. 10 is a network in which access to content is migrated between receiving systems.

FIG. 11 is a flow diagram of a mode of adaptively receiving the content of a scalable codestream as it is migrated between systems having different capabilities.

FIG. 12 is a network in which access to content of a scalable codestream provided by one system is adaptively received over time by a second system.

FIG. 13 is a flow diagram of a mode of adapting an access level used in recording a program based on storage space available for recording the program.

FIG. 14 is a flow diagram of a mode of recording a program at a desired access level by reducing access levels used in storing previously-recorded programs by truncating data supporting the original access levels.

FIG. 15 is a functional diagram of a computing system environment suitable for use in adaptively receiving or sending content of a scalable codestream.

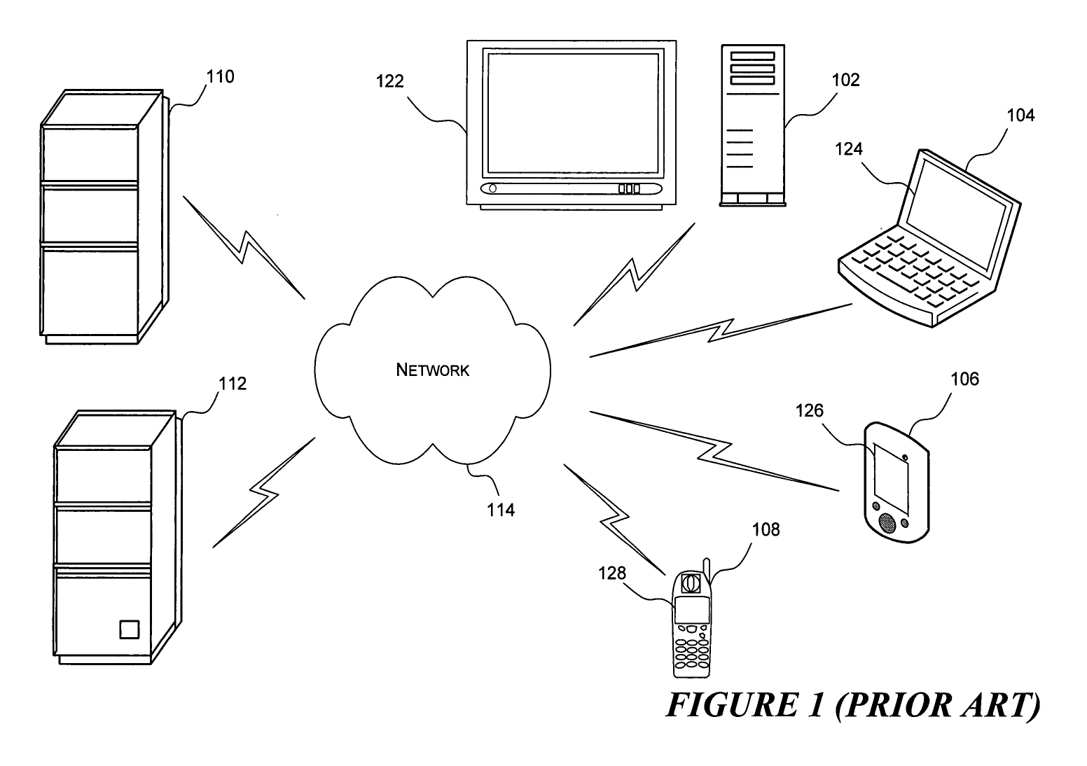

### DETAILED DESCRIPTION

To take best advantage of scalable codestreams for video and other forms of media content, an adaptive architecture for sending and receiving the video content is desired. In the case of motion video content, a scalable codestream allows for video content to be accessed at the level of resolution—or access levels of other types—up to the highest resolution supported by the codestream and the accessing device. Alternatively, the scalable codestream also allows the device to access the codestream at a lower access level to permit faster access to the content, such as to allow for workable access over lower bandwidth connections. Desirably, the systems using an embodiment of an adaptive architecture to adjust the selected access level based on capabilities of the device currently used to access the content, available bandwidth, user preferences, or other factors.

An architecture that permits adaptive communication between the sending and receiving devices facilitates a number of features. First, the architecture promotes scalable distribution. For example, scalable digital rights management facilitates charging for media content based on the access level selected. The architecture allows the receiving system to adapt to access the content of the scalable codestream at the permitted level. Also, in a video teleconference situation or other situations where different participants use devices with different media capabilities, the codestream can be adaptively processed so that each user is able to access the codestream at an optimal resolution. However, unlike conventional access to a non-scalable codestream, the sending and/or receiving devices can send and receive, respectively, only desired portions of the scalable codestream to reduce waste of computing or communication resources.

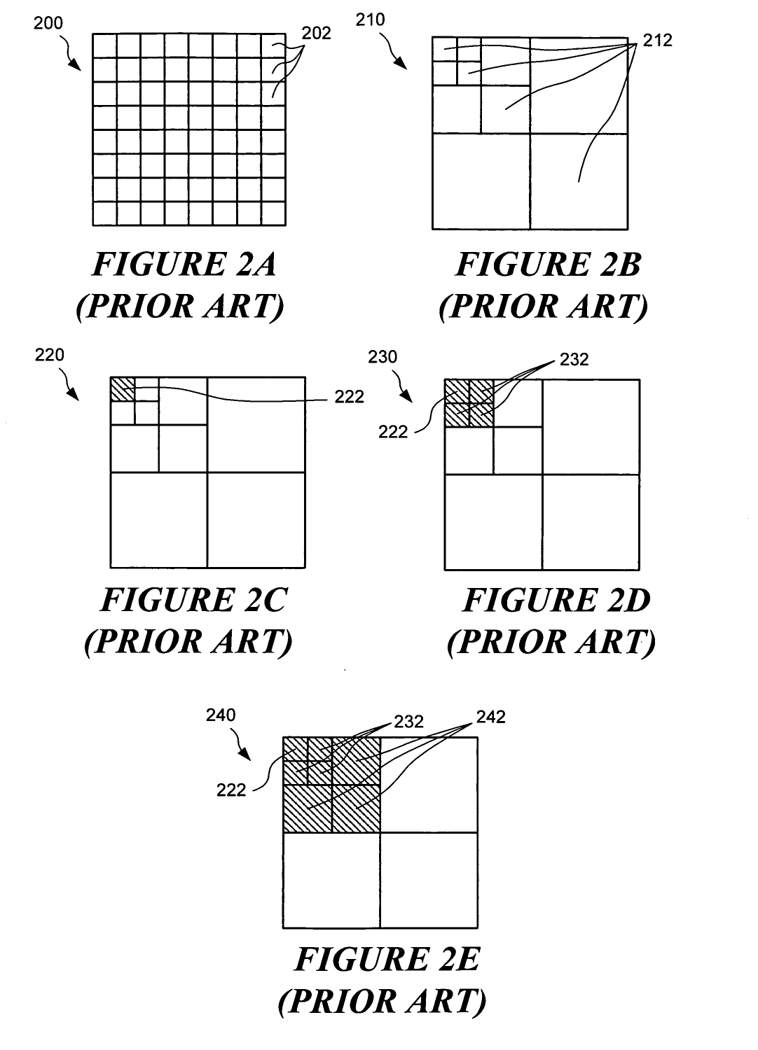

Correspondingly, not only does the architecture allow multiple systems to receive and selectively access a codestream from a single sending system, but it also allows a single system to receive a codestream from multiple sources. As is understood in the art and has been previously described in connection with FIGS. 2A through 2E, a scalable codestream includes discrete, constituent elements that represent different access levels to the content presented by codestream. Thus, multiple systems may send different constituent portions of the codestream to a receiving system, allowing the receiving system to receive all of the constituent elements to allow the receiving system to access the codestream at high access levels more quickly than would be possible if the codestream were being provided by a single sending system.

Second, the architecture provides migration of a codestream from one device to another. Thus, the architecture permits “device roaming.” For example, if a user originally receives the content using a high resolution device, such as a portable computer, but then switches to a lower resolution handheld device, such as a personal digital assistant, handheld computer, mobile phone, or gaming system, access to the content of the codestream is automatically adapted to allow the user to continue to access the content regardless of the changes of capability between the devices. A user can switch back and forth between receiving devices. Thus, a user viewing one program on a high resolution video monitor while monitoring a second program on a lower resolution handheld device can switch which program is being viewed on each device.

Adaptive distribution also promotes time-dependent scaling of content. For example, if a user is recording a program and is running out of storage space, the adaptive distribution allows the receiving device to reduce the access level of the content being received to be able to fit the program into available storage space. Similarly, if a user is receiving multiple files, the files may all be received at a reduced access level to provide the user with all at least low access level versions of all the content requested. Then, when the user later is receiving files again or is accessing the files, additional data to increase the access level is received to supplement the original data received. Also, for users performing video content analysis and editing, users can retrieve, edit, and sort the content based on lower-access level content, and when the piece has been edited, additional data to supplement the lower-access level content is retrieved.

The functions are facilitated by systems including a peering subsystem, a network engine, a kernel, and a communications control subsystem to monitor and adapt codestream communications being sent and received, as is described in detail below.

Architecture Facilitating Adaptive Communication of Video Content

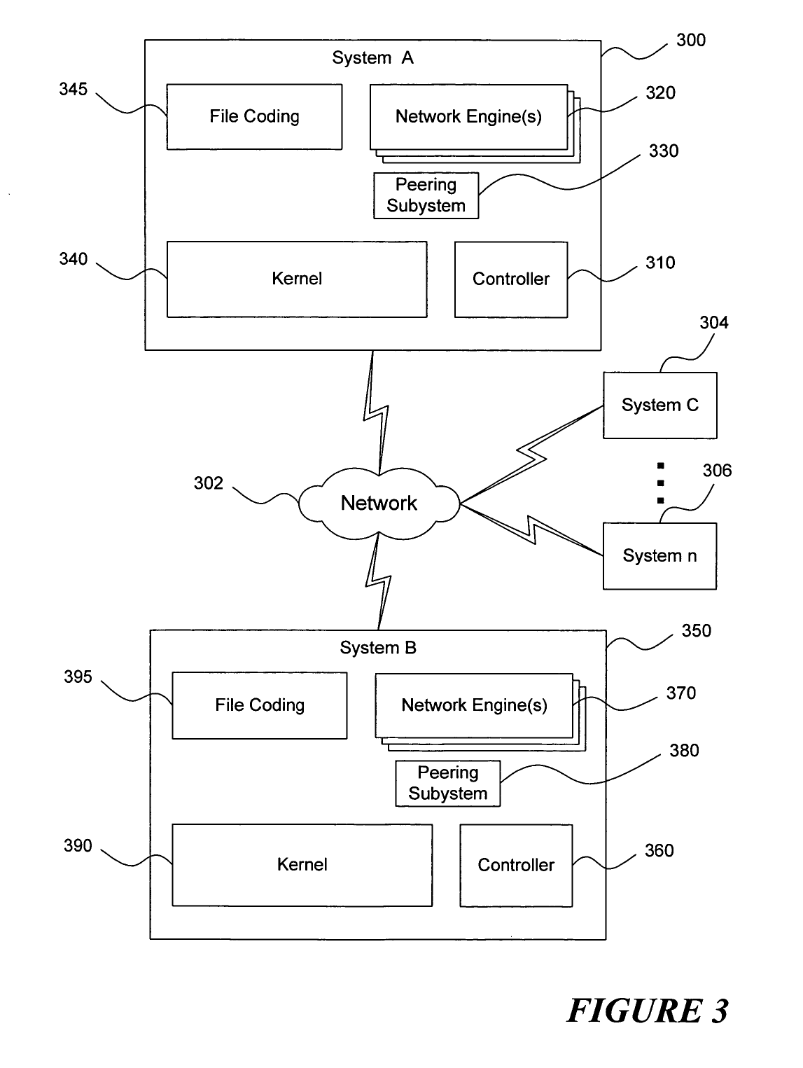

FIG. 3 is a high-level block diagram of an embodiment of an architecture operable to exchange data and control signals to take advantage of scalable codestreams. FIG. 3 includes two systems, System A 300 and System B 350, each of which uses an embodiment of the architecture and is able to communicate with one another over a network 302. System A 300 and System B 350 are also able to communicate over the network 302 with other systems, including System C 304 through System n 306. The network 302 is depicted as a single network through which each of the systems 300, 304, 306, and 350 communicates. However, the systems can communicate peer-to-peer over different networks. For example, while System A 300 and System B 350 may communicate over a wide-area network such as the Internet, System B 350 might communicate with System C 304 via a Bluetooth network or some other form of network medium.

More specifically, an embodiment of the architecture illustrated in System A 300 and System B 350 allows the systems to monitor network and device capabilities and exchange control signals to optimize the exchange of data signals. Both System A 300 and System B 350 include four general subsystems: controller subsystems 310 and 360, network engines 320 and 370, peering subsystems 330 and 380, and kernels 340 and 390. System A 300 and System B 350 also direct coding subsystems 345 and 395, respectively. File coding subsystems 345 and 395 may include any of a number of known coding systems used to encode and decode files for data transmission.

By way of overview, the controller subsystems 310 and 360 provide user control of media flow, such as by launching media applications and processing user commands. The controller subsystems 310 and 360 also monitor resources to control or restrict the data flow to levels that the local system can accommodate. The controller subsystems 310 and 360 also cooperate between the server side and the client side to monitor quality of service (QoS) reports and requests to adapt the flow of data between the sending or server side and the receiving or client side. Thus, to facilitate transmission of one codestream to multiple receiving systems or to facilitate reception of constituent elements of a codestream from multiple sending systems, the controller subsystems 310 and 360 exchange control information about the codestreams or portions of codestreams being sent and received by the systems participating in the communication.

The network engines 320 and 370 control data transmission operations. For example, on the receiving the network engine performs packet reordering, sending non-acknowledgment (NACK) messages for missing transport packets, transmits QoS information and client requests, and similar functions. On the sending system, in addition to receiving QoS information and client requests, the network engine directs data transmission, maintains a re-sending buffer for transport layer packets that are not acknowledged by the client, and handles automatic repeat request (ARQ) processing.

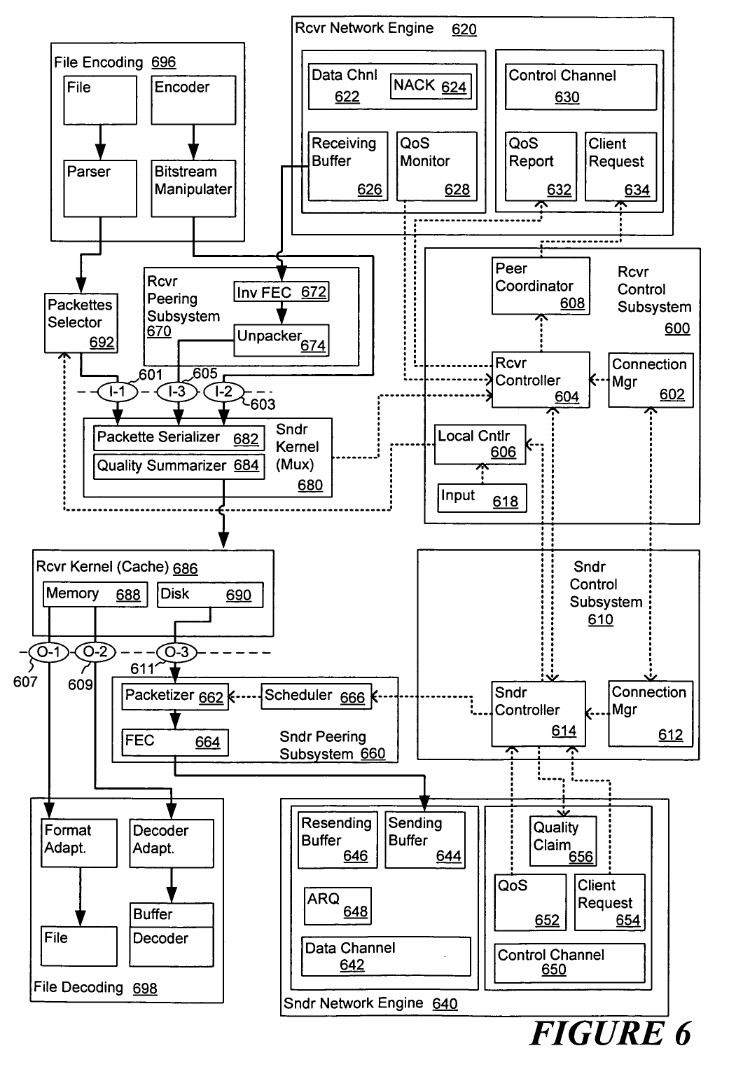

In one embodiment, System A 300 and System B 350 each include multiple network engines 320 and 370, respectively, to support collaborative streaming. Collaborative streaming, as previously described, allows one system to send or receive multiple codestreams. As will be described below in connection with FIG. 6, the network engines 320 and 370 include data channels, buffers, and other components to send data to and receive data from other systems.

System A 300 and System B 350 also include peering subsystems 330 and 380. As is explained in further detail below, the peering subsystems on the sending system receives the codestream from the file encoding subsystem 345 and selects portions of the coding units in the codestream. The selected portions are included in transport packets to be sent to one or more receiving systems. The peering subsystem 330 handles this selection and packettization of the selected portions, thus the process is transparent to the file coding subsystem 345 on the sending system, System A 300. In one embodiment, the peering system also performs forward error correction (FEC) on the transport layer packets.

On a client side, the peering subsystem 380 unpacks the selected coding units of data from the incoming transport layer packets for processing by the file decoding system. In one embodiment, the peering subsystem 380 also performs inverse FEC on the incoming transport layer data packets.

System A 300 and System B 350 also include kernel subsystems 340 and 390, respectively. On a sending system, the kernel subsystem multiplexes data and control data. On a client side, the kernel subsystem includes a memory and/or storage cache for receiving and staging the data for access by the receiving system.

The control subsystems 310 and 360, network engines 320 and 370, peeing subsystems 330 and 380, and kernel subsystems 340 and 390 communicate with one another to adaptively extract, send, receive, and unpack the selected coding units from the scalable codestream to provide efficient and flexible access to desired media content. The access is efficient because coding units that are not used are not sent and/or accessed. The access is flexible because the peering subsystems 330 and 380 can adjust the number of coding units that are exchanged and/or accessed during the exchange of the media content based upon the control signals exchanged by the other subsystems. Accordingly, the selected access level of the codestream can be changed during the transmission, without restarting, rebuffering, or otherwise reinitiating the exchange of media content.

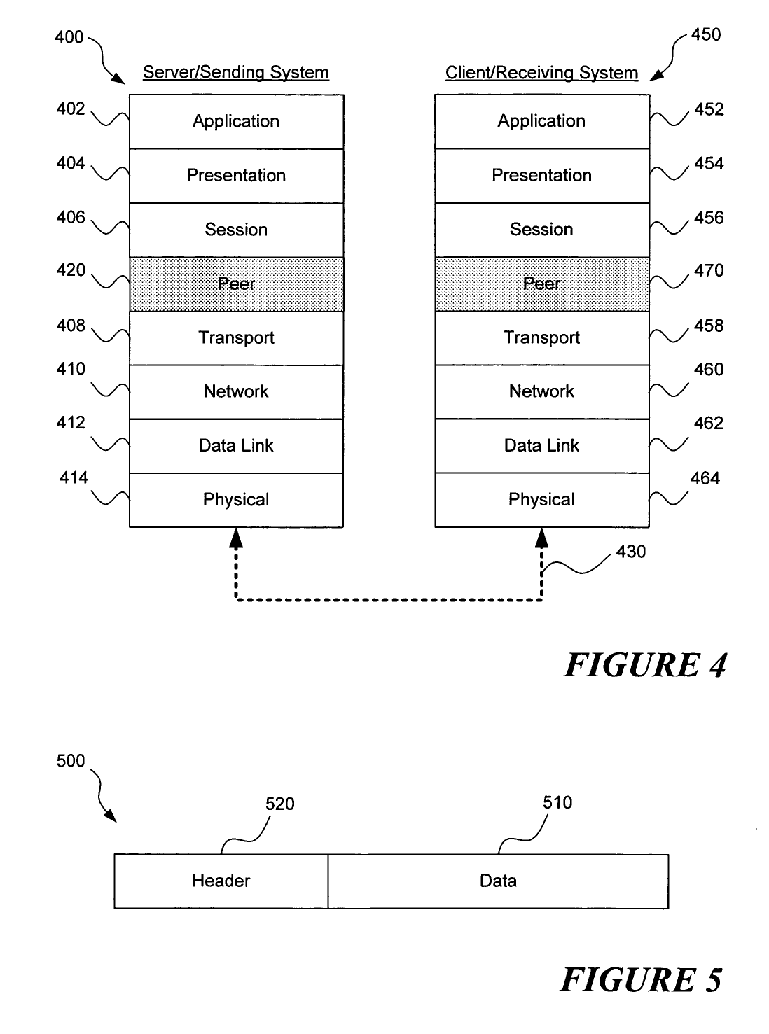

FIGS. 4 and 5 illustrate two additional attributes of an embodiment of the architecture. First, FIG. 4 shows an additional logical layer used by an embodiment of the architecture in a layered communications protocol in both a server or other sending system 400 and a client or other receiving system 450. A conventional sending system observing an International Standards Organization Open Systems Interconnection (ISO-OSI) protocol typically includes an application layer 402, a presentation layer 404, a session layer 406, a transport layer 408, a network layer 410, a data link layer 412, and a physical layer 414. Similarly, a conventional receiving system includes an application layer 452, a presentation layer 454, a session layer 456, a transport layer 458, a network layer 460, a data link layer 462, and a physical layer 464. The physical layer 414 of the sending system 400 is in communication with the physical layer 464 over a network medium 430.

FIG. 4 shows an additional layer added to the sending system 400 and the receiving system 450 to make the architecture transparent not only to the application layers 402 and 452, but to the other layers of the protocol as well. In one embodiment, a peer layer 420 is added to the sending system 400 above the transport layer 408, and a corresponding peer layer 470 is added to the receiving system 450 above the transport layer 458. The peer layers 420 and 470 work with packettes to adaptively transmit and receive media codestreams according to an embodiment of the architecture.

The peer layers 420 and 470 provide multiple advantages. First, for example, the peer layers 420 and 470 allow for the packing and unpacking, respectively, of minimum units of data into packeftes that can be included in transport packets that are assembled by the transport layer 408 and other layers of the sending system 400 in sending data via the network medium 430 to the receiving system 450. Upon receiving transport packets from the transport layer 458 of the receiving system 450, the peer layer 470 of the receiving system 450 then unpacks the packettes from the transport packets transmitted by the sending system 400. In other words, packettes are packed and unpacked by the peer layers 420 and 470 and provided to the transport layers 408 and 458, respectively. Accordingly, embodiments of the architecture are not dependent on any particular packetization mechanism that may be used by the transport layers 420 and 470, or by other layers in the systems. Moreover, the assembly and unpacking of packettes is performed transparently with regard to the other layers.

Another advantage of adding the peer layers 420 and 470 is that their presence decouples the application layers 402 and 452 from the transport layers 408 and 458, respectively. Decoupling these layers supports functions such as device roaming, which is mentioned above and described in more detail below. The peer layers 420 and 470 perform the selective assembly and selection of packettes to permit the application layers 402 and 452 to engage the codestream at an access level that each system can accommodate transparently with regard to either the application layers 402 and 452 and the transport layers 408 and 458.

In the alternative, instead of adding the peer layers 420 and 470 to the seven-layer ISO-OSI protocol, the peer layers 420 and 470 can incorporate functions of other layers and supplant those layers, and other layers may be combined as well. To name just one example, a three-layer model may be appropriate for both the sending system and the receiving system, where the three layers, include an application layer, a peer layer, and a transport layer. In such a model, the peer layer collects selected coding blocks into packettes to support the applications, and collects the packettes into transport packets to be communicated by the transport layer. Thus, comparable to the eight-layer model derived by adding a peer layer, the three-layer model includes a peer layer to support the media applications, while forming or unpacking the packettes in a manner that is independent of and transparent to the application and transport layers.

FIG. 5 shows a diagram of a packette 500 used in an embodiment of the architecture. The packette 500 is a coding unit used by an embodiment of the architecture to exchange data between the sending system 400 and the receiving system 450 (FIG. 4). The packette 500 includes a data section 510, including one or more minimum coding units of data. A minimum coding unit suitably includes a sequence of bits which are syntactically compliant with the specific codestream format. Preferably, the minimum coding units are related to the minimum block division of a frame, image, or other media unit. Thus, in the example of video coding, the minimum coding unit can be a macroblock. A header 520 is appended to the data section 510. The header 520 includes some assisting information identifying the contents of the packette 500.

Embodiments of the architecture are not limited to any particular packette structure, and there are multiple possibilities for forming the packettes 500. To name one example, packettes 500 may be formed by specifying a fixed maximum data length for data section 510, and including as many minimum coding units as will fit into to it. Alternatively, packettes 500 may include a fixed number of minimum coding units. The minimum coding unit itself is application configurable. For example, the minimum coding structure may include a single macroblock for video coding. Alternatively, the minimum coding structure may include multiple macroblocks.

The header 520 of the packette 510 may include the packette length, stated in bytes or other units recognized by the architecture. The header 520 also may include a frame number or time stamp of the frame of which the minimum coding units are a part, a bit plane number, a starting macroblock index number, an end macroblock index number, a number of useful bits in the last byte, and other information. When the header 520 includes macroblock index numbers, the data section 510 includes the bits representing the macroblocks from the starting index through the end index specified in the header 510. Thus, when the header 520 includes the starting macroblock index and end macroblock index, the header 520 provides a metric for the quality of a received frame. Alternatively, however, the header 520 may include a quality index field to indicate the quality of the frame made available upon successfully receiving the current packette and the preceding packettes including data representing the frame.

Detailed Example of Architecture Facilitating Adaptive Communication

FIG. 6 is a functional block diagram of an exemplary embodiment of systems employing an embodiment of the architecture to exchange data and control signals to take advantage of scalable codestreams. The data signals are represented by solid lines, while the control signals are represented by dotted lines. More specifically, FIG. 6 is a functional block diagram that illustrates the interrelationships between subsystems when a server or sending system is providing a codestream to a client or receiving system. It should be noted that the subsystems of the sending system and the receiving system are distributed throughout the functional block diagram of FIG. 6 to illustrate the functional interrelationship between the subsystems.

Ultimately, the data is passed from a file encoding system 696 on a system sending the data to a file decoding system 698 on a system requesting and receiving the data. A multitude of coding and decoding systems are known in the art, and embodiments of the architecture for adaptive communication of scalable codestreams are not limited to any particular encoding and decoding topologies.

A receiver control subsystem 600 and a sender control subsystem 610 cooperate to control the codestream transmission between the sending system and the receiving system. Both the receiver control subsystem 600 and the sender control subsystem 610 support connection managers 602 and 612, respectively. In one embodiment, the connection managers 602 and 612 are the only daemon threads that are always running in order to monitor a port for codestream-related communications.

The connection manager 602 on the receiving system provides an interface that allows a user to launch an application that uses the scalable codestreams. The connection manager 602 also accepts user commands, such as START, PAUSE, STOP, and similar media control commands. The connection manager 612 on the sending system responds to communications generated by the connection manager 602 on the receiving system. The connection managers 602 and 612 communicate with each other, and with other peer connection managers, to perform security checks for user authentication, identification verification, and similar functions. In addition, the connection managers 602 and 612 provide input to the receiver controller 604 and the sender controller 614, respectively.

The receiver controller 604 manages functions on the receiving system in cooperation with the sender controller 614 on the sending system. The receiver controller 604 receives data from the sender kernel 680 that multiplexes the codestream regarding the quality of the transmission from the sending system. The receiver controller 604 also receives QoS information from the receiver network engine 620, and generates quality of service reporting information to the sending controller 610. The receiver controller 604 engages a peer coordinator 608 that provides information to the receiver network engine 620 to coordinate among peers for better cooperative streaming, according to the network status among peers and user commands.

The receiver controller subsystem 600 also includes a local controller 606. The local controller 606 determines which packettes will be selected to the sender kernel 60 to be multiplexed and delivered to the receiver kernel 6 where the codestreams will be cached on the receiving system. The local controller 606 receives input 618 that may include input from a user seeking smoother motion, better quality, or other attributes during the presentation of the codestream on the receiving system.

In addition, the local controller 606 may receive input 618 regarding the processing status of the receiving system. Thus, if the receiving system does not have the capability to store or process the data being received, or if bandwidth is limited, further input 618 is provided to the local controller 606 to indicate that the playback quality should be reduced. The local controller 606 communicates with a packettes selector 692 to reduce the number of packettes being transmitted. Thus, the local controller 606 can restrict the number of packettes to be selected so that the playback can last longer while at a degraded quality.

The sender control subsystem 610, in addition to the connection manager 612, also includes a sender controller 614. The sender controller 614 communicates with receiver controller 604. The sender controller 614 receives client requests to access media and the QoS status from the sender network engine 640. The sender controller 614 communicates the desired media quality to the local controller 606. The sender controller 614 communicates to the scheduler 666 of the sender peering subsystem 660 to perform scheduling, with possible cross-frame optimization of packets considering the client request. Cross-frame optimization can still be performed if such optimization information is passed at regular interval for multiple frames, or the scheduler 666 can be permitted to perform the optimization. The sender controller 614 also specifies a quality claim specifying the capability of the receiving system that can be used by other systems in performing peer coordination.

The receiving system also includes a receiver network engine 620. The receiver network engine 620 includes a data channel 622 that engages a transport layer or directly performs data transmission using user datagram protocol (UDP), rapid transport protocol (RTP), or other protocols. The data channel 622 includes a non-acknowledgement generator (NACK) 624 to communicate to signal the sending system when missing transport packets are identified. The data channel 622 maintains a receiving buffer to perform necessary reordering if transport packets are out of order. The data channel 622 also estimates the network status parameters to monitor QoS and communicate the QoS information to the receiver controller 604.

The receiver network engine 620 also includes a control channel 630. The control channel 620 receives QoS reports 632 and receives client requests 634. The control channel 620 also works with the transport layer to control or directly communicates control information using TCP, RTCP, or other protocols.

The sending system also includes a sender network engine 640. Like the receiver network engine 620, the sender network engine 640 includes a data channel 642 that maintains a sending buffer 644 for holding transport packets. Directly, or in concert with a transport layer, the data channel 642 performs data transmission using UDP, RTP, or other protocols. The data channel 642 also maintains a re-sending buffer 646 for base layer transport packets or other packets subject to ARQ. In one embodiment, two resending queues are maintained: a first queue for transport packets that will be resent if missing, and a second queue for transport packets for which ARQ is not necessary. The data channel 642 also includes an ARQ handler 648 to resend transport packets as needed.

The sender network engine 640 also includes a control channel 650. The control channel 650 maintains a QoS handler 652 to receive QoS parameters from client systems. The control channel 650 also maintains a client request handler 654 to receive client requests. In addition, the control channel 650 includes a quality claim handler 656 to track quality claims regarding peer clients.

Both the sending and receiving systems also include peering systems. A sender peering system 660 performs includes a packetizer 662 and a forward error correction (FEC) handler 664. The packetizer 662 forms the selected data into packettes, and collects the packettes into transport packets as designated by the scheduler 666. The FEC handler 664 performs forward error correction of the packets. A receiver peering system 670 includes an inverse FEC handler 672 to perform inverse error correction. The receiver peering system 670 also includes an unpacker 674 to unpack the packettes from the transport packets generated by the packetizer 662.

The sending and receiving systems each also include a kernel. The sender kernel 680 is a multiplexer that includes a packette serializer 682 and a quality summarizer 684 that provides a quality summary for each access unit. The receiver kernel 690 is a caching system that includes a memory 6 and disk storage 690. The cache size determines the number of asynchronous clients that a single streaming session of a program can support. If the cache size is large enough to hold the whole streaming file, then all the clients can be supported with one instance of the streaming server. For a specific client, a quality constraint can be specified by the local controller 606 to the packettes selector 692 so that only the necessary number of packettes is passed to the sender kernel 680. When multiple clients are to be supported with a single session, the quality constraint should be specified at the highest level needed to serve the client specifying the highest access level.

The block diagram also graphically depicts where a plurality of application program interfaces (APIs) engage the subsystems to allow applications to integrate with the peering subsystems and the kernels to control the access levels used in communicating the media content. More specifically, FIG. 6 shows three input APIs, I-1 601, I-2 603, and I-3 605, and three output APIs, O-1 607, O-2 609, and O-3 611.

API I-1 affects the flow of the packettes from the packettes selector 692 to the packette serializer 682. API I-2 603 controls the flow of data from the file encoding system 696 to the packette serializer 682. API I-3 605 controls the flow of data from the unpacker 674 to the packette serializer 682. API O-1 607 and O-2 609 both affect the flow of data from the memory 688 of the receiver kernel 686 to the file decoding subsystem 698. API O-3 611 affects the flow of data to the packetizer 662. Thus, applications can use these APIs to control what data are sent or are accessed in presenting or accessing codestreams at different access levels.

Process of Facilitating Adaptive Communication

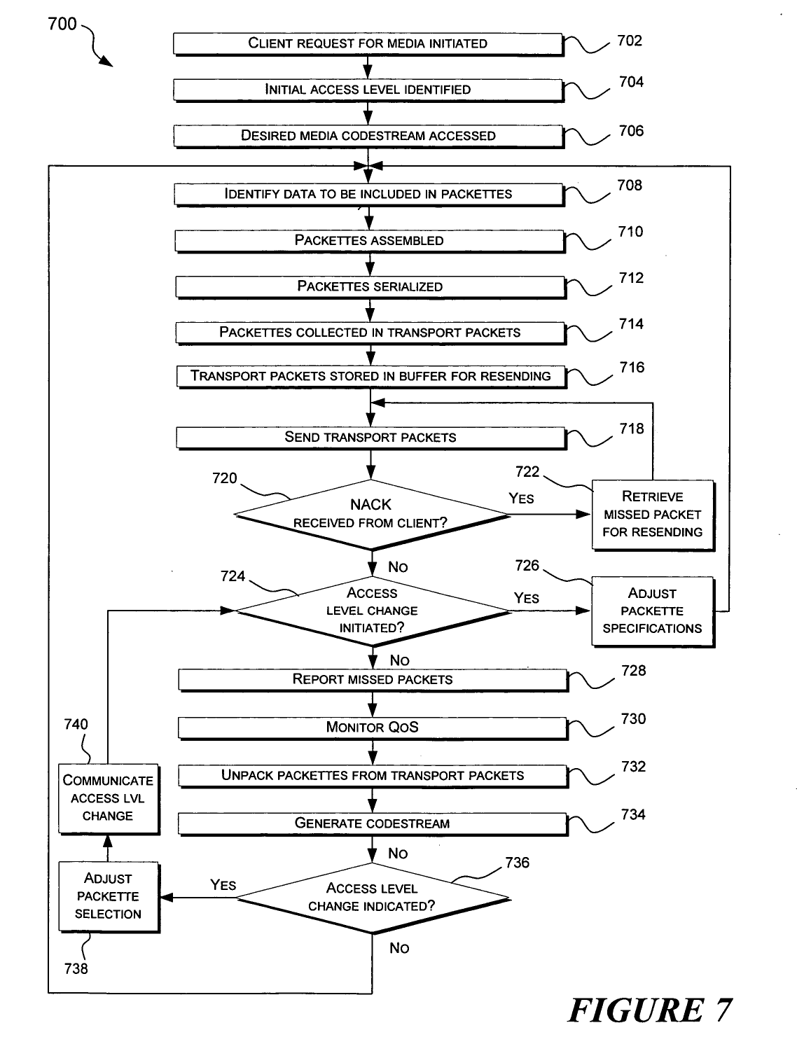

FIG. 7 is a flow diagram of a mode of facilitating adaptive communication using an architecture as described in FIGS. 3 and 6, or a similarly capable system. The process 700 illustrates actions performed by the sending system and the receiving system, including actions performed cooperatively by both systems.

The process 700 begins at 702 with a client initiating a request for media content. At 704, an initial access level is identified. The initial access level may be a default level or determined by the receiving system and/or the sending system based on preferences, processing and bandwidth capabilities, or other factors. At 706, the media codestream is accessed and, at 708, the data to be included in the packettes is identified. At 710, the packettes are assembled. At 712, the packettes are serialized. At 714, the packettes collected in transport packets. At 716, a number of the transport packets are collected in a buffer from which they can be resent if the packets are not received and thus are not acknowledged by the receiving system. At 718, the transport packets are sent to one or more receiving systems.

At 720, it is determined if a packet is not acknowledged by one or more receiving systems. If so, at 722, the missed packet is retrieved from the buffer for resending, and the process 700 loops to 718 to resend the missed packet. On the other hand, if all packets are acknowledged, at 724, it is determined if an access level change is indicated as a result of a user input, system conditions, or other factors. If so, at 726, packette specifications are adjusted. Such an adjustment may involve additional coding units being included in packettes, or more packettes being selected for sending. The process 700 loops to 708 for the data to be included in the packettes to be identified based on the indicated change.

On the other hand, if it is determined at 724 that no access level change has been initiated, moving to actions performed by the receiving system, at 728, missed packets are reported by sending NACK messages to the sending system (which are detected at 720 as previously described). At 730, the quality of service is monitored for possible changes in the access level of the media content. At 732, the packettes are unpacked from the transport layers. At 734, the codestream is generated for presentation by the receiving system.

At 736, it is determined if an access level change is indicated either by system conditions or a user selection. If so, at 738, the packette selection is adjusted on the local system. Thus, if a local access level change is indicated, without changing the packettes being sent from the sending system, the local system can adjust the access level. The access level may be changed to a higher level than is currently being presented on the receiving system if a sufficient number of packettes are being sent and/or the packettes include sufficient coding units to permit a higher access level. If the access level is to be reduced, the access level can be reduced by reducing the number of packettes being accessed.

In addition, at 740, an access level change also may be communicated to a sending system. Thus, if the receiving system is reducing the access level, the reduction may be communicated to the sending system to reduce the number of packettes being sent to reduce processing and/or bandwidth being used. If multiple receiving systems are receiving the codestream, the codestream may be unchanged.

On the other hand, if it is determined at 736 that no access level change is indicated, the process loops to 708 to continue the identification of data to be included in packettes to be provided by the sending system.

Exemplary Supported Applications

Embodiment of adaptive architectures as previously described support a number of enhanced media access applications, including providing multiple access level streaming of media content, device roaming, and time-dependent access level shifting.

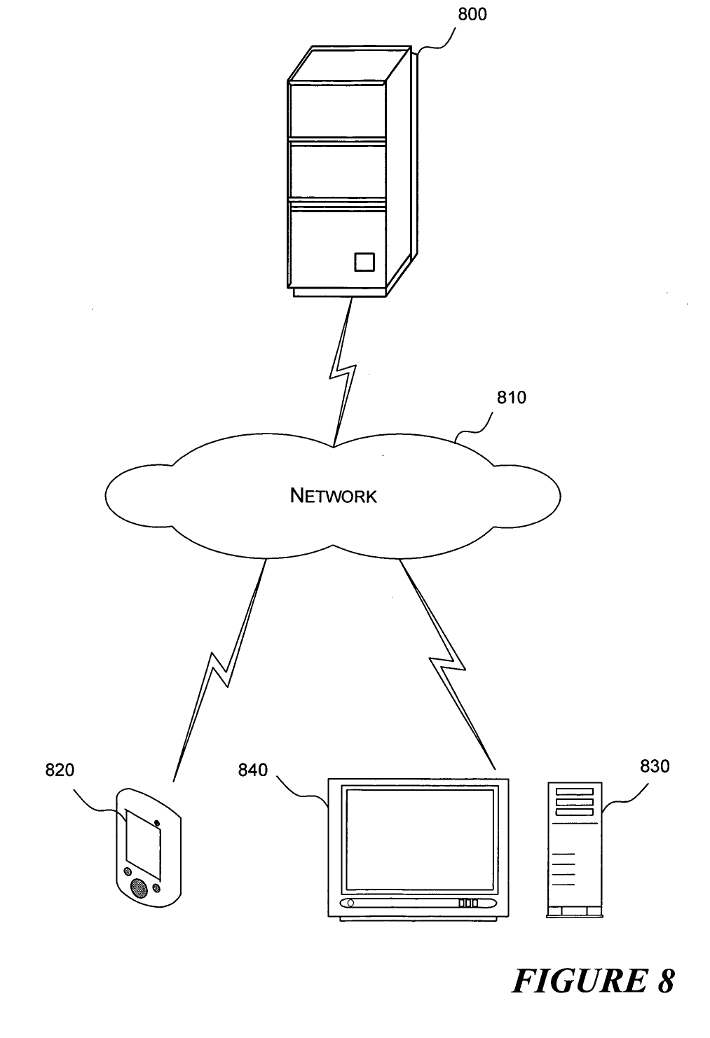

To illustrate multiple access level streaming, FIG. 8 shows a network of a sending system 800 communicating media content via a network 810 to a plurality of systems 820 and 830 having different capabilities for presenting media content. Using an architecture such as that illustrated in FIG. 6, the access level employed by a receiving system can be changed on the local system and changes in access levels also can be communicated between sending and receiving systems.

More specifically, in FIG. 8 one of the receiving systems is handheld computer 820, while the other receiving system is a personal computer 830, such as a media computer, coupled with a high resolution video monitor 840. For purposes of the example of FIG. 8, it can be assumed that systems 820 and 830 employ different access levels because each of the systems features a differently-enabled display. However, a difference in desired access level may be a function of different network bandwidths available to the systems, different digital rights management authorization between the systems, or other reasons. In the example of FIG. 8, the media content may be provided by a sending system in a one-way transaction, or the media content may be part of an interactive video conference call.

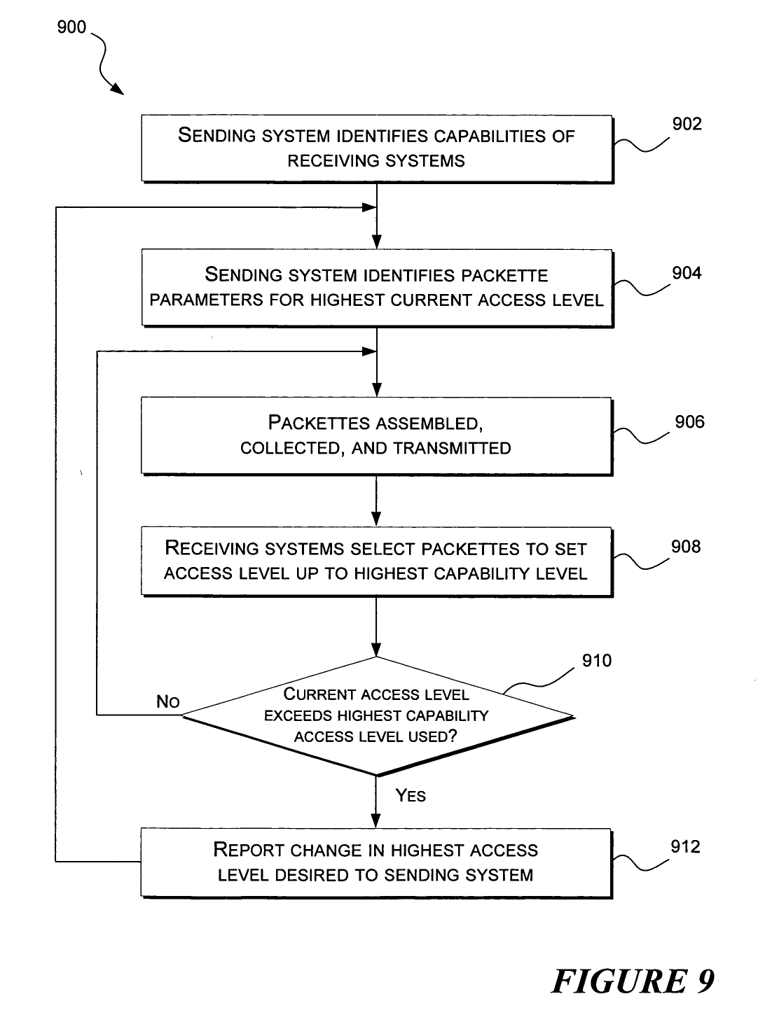

FIG. 9 is a flow diagram of a process 900 employed in the interaction between the serving system 800 and each of the receiving systems 820 and 830. At 902, the sending system identifies the capabilities of the receiving systems in order to determine the appropriate access level of the media content to be provided. For example, if all of the receiving systems are limited by bandwidth, processing, display, or other limitations, the sending system may provide the media content at a reduced access level to avoid unnecessary use of processing and bandwidth resources. At 904, based on the highest current access level supported by the receiving systems, the sending system identifies packette parameters, including the number of packettes to be sent. In one mode, the access level is selected based on the highest capabilities among the receiving systems. Accordingly, each of the receiving systems can locally adjust the access level up to the highest level provided or to a lower level without affecting the access level provided to other receiving systems.

At 906, the packettes are assembled, collected, and transmitted. At 908, each of the receiving systems selects which packettes or which coding units included in the packettes will be accessed to determine the local access level. Each of the receiving systems, based on capabilities or user preferences, can access the packettes to present the media content at an access level up to the highest access level made possible by the packettes sent by the sending system, or at a lower access level.

In one mode, at 910, it is determined if the current access level exceeds the highest capability access level that is currently being used. If so, at 912, the current access level is reduced to the highest access level being used to reduce unnecessary use of processing and/or bandwidth resources. The process 900 then loops to 904 for the packette parameters to be changed. On the other hand, at 910 if it is determined that the current access level does not exceed the highest capability access level being used, the routine 900 loops to 906 for the packettes to continue to be assembled, collected, and transmitted.

It will be appreciated that if even one other receiving system can access the media content at the highest possible access level based on the packettes being sent, that no one receiving system should be able to undermine the access level of another system. However, as in the exemplary case of FIG. 8, the personal computer 830 with the high resolution video monitor 840 is capable of presenting higher resolution images than handheld computer 820. The original access level identified by the sending system at 904 is selected to serve the more capable system 830, which is likely a higher access level than can be supported by handheld system 820. Then, if the access level at which the media content is engaged on the more capable system 830, it would be a waste of resources for the sending system to present the media content at any higher level. Accordingly, at 912, the change in access level is reported to the sending system and, the process loops to 904 for the packette parameters to be changed.

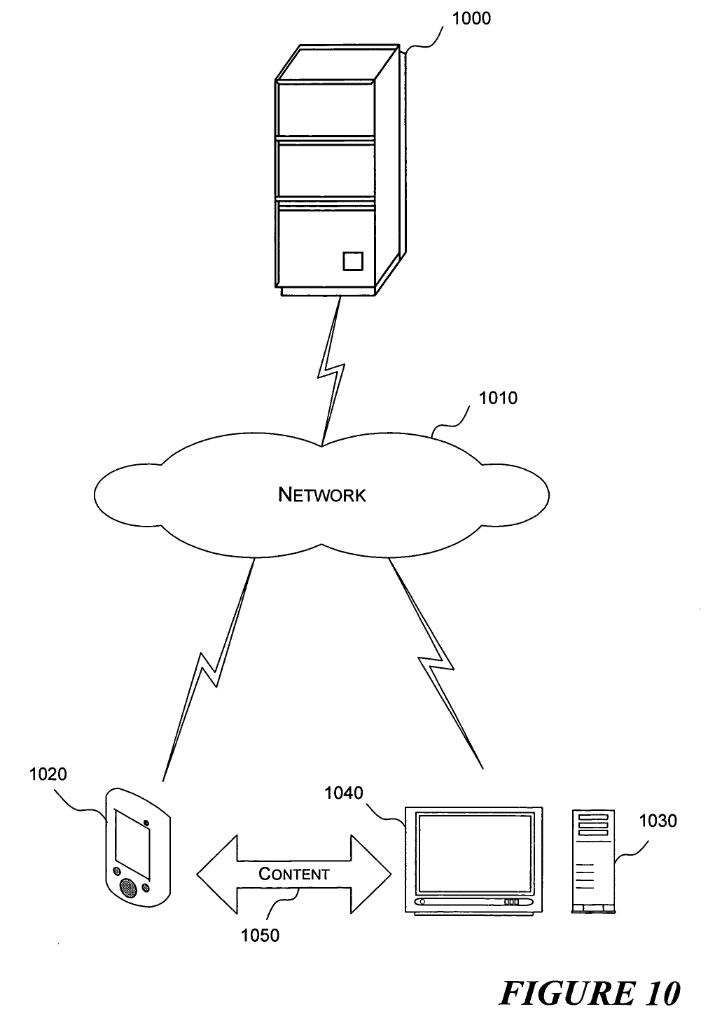

To illustrate device roaming, FIG. 10 shows a network of a sending system 1000 communicating media content via a network 1010 to a plurality of systems 1020 and 1030 that may have equivalent or different capabilities for presenting media content as previously described in connection with FIG. 8. Again, handheld device 1020 is assumed to have lesser media access capabilities than personal computer 1030 which is associated with a high resolution video monitor 1040. In contrast to the example of FIG. 8, however, in FIG. 10, the content 1050 being received by the receiving devices 1020 and 1030 may not be the same, and the content 1050 is migrated from one of the other receiving devices to the other, or the content received by each receiving device is swapped. For example, a user may be viewing a media program on the handheld device 1020, but then decides she wishes to access the media program on a higher resolution device. Alternatively, the user may be viewing one media program on the personal computer 1030 and high resolution video monitor 1040, while monitoring a second program on the handheld device 1020, and the user may wish to swap the media programs between the receiving devices 1020 and 1030.

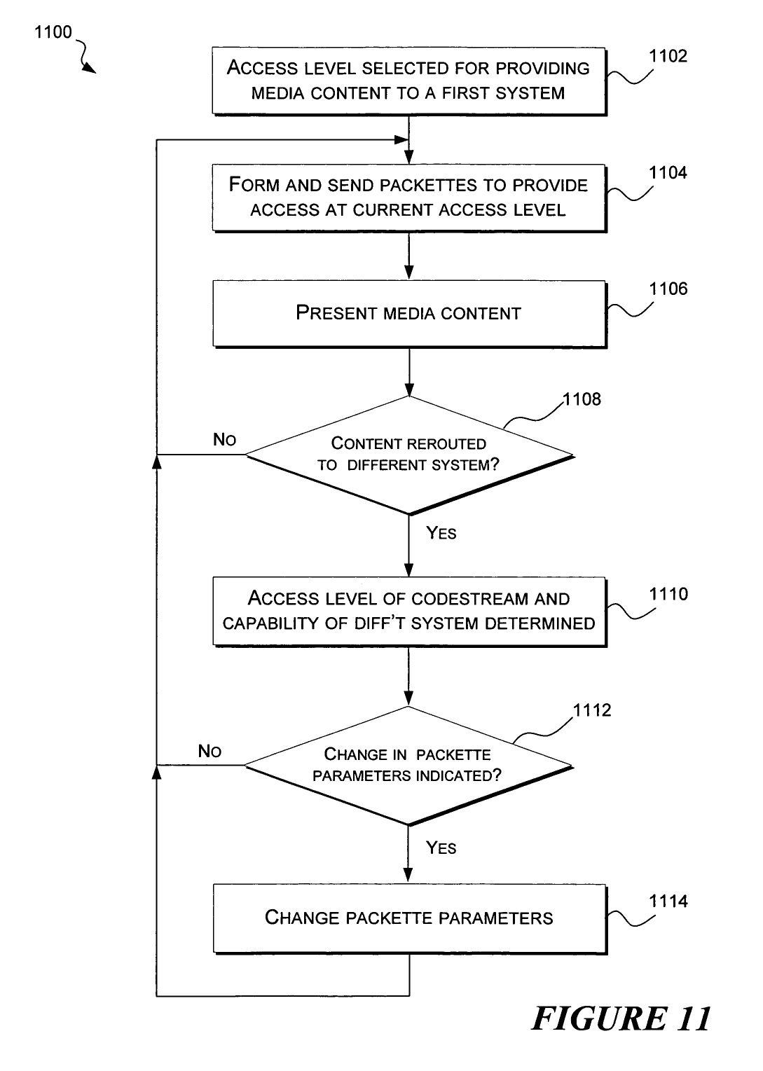

FIG. 11 shows a flow diagram of a process 1100 employed in the migrating a codestream between receiving devices. At 1102, an access level is selected for providing media content to a first system. The access level, as previously described, is based on user preferences, system capabilities, digital rights management permissions, or other factors. In addition, although not shown in FIG. 11, if a different system is being used to access different media content, the access level is determined for the different system in the same manner. Once the access level is selected (for each of one or more systems) at 1104, packettes are formed and sent for presenting the media content at the currently selected access level(s). At 1106, the media content is presented.

At 1108, it is determined if the content from one (or both) of the systems is to be routed to a different system, for example, if the user elects to migrate or swap media content from one device to another. If not, the process 1100 loops to 1104 for packettes to be continued to be formed and sent at the current access level(s). On the other hand, if it is determined at 1108 that the content is to be rerouted to a different system, at 1110, a desired or appropriate access level for the different system is identified. At 1112, it is determined if a change in the packette parameters is indicated based on the access level identified for the different system. If not, the process loops to 1104 where packettes will continue to be presented to support the current access level. However, if a change in the packette parameters is indicated, at 1114 the packette parameters are changed, and the process again loops to 1104 for packettes to be formed at the new current access level.

Although not expressly shown in FIG. 11, the case where content is swapped between the handheld device 1020 (FIG. 10) and the personal computer 1030, there are two migrations that take place. One migration involves the content being accessed by the handheld device 1020 being migrated to the personal computer 1030, and the other migration the content being accessed by the personal computer being migrated to the handheld device 1020. Based on the earlier descriptions, it will be appreciated that the second migration to the handheld device will not necessarily involve a change in how the packettes are prepared; how the packettes are accessed on the handheld device 1020 can be used to control the access level at the local level. Only if the packette parameters are insufficient to support a higher level of access do the packette parameters need to be changed.

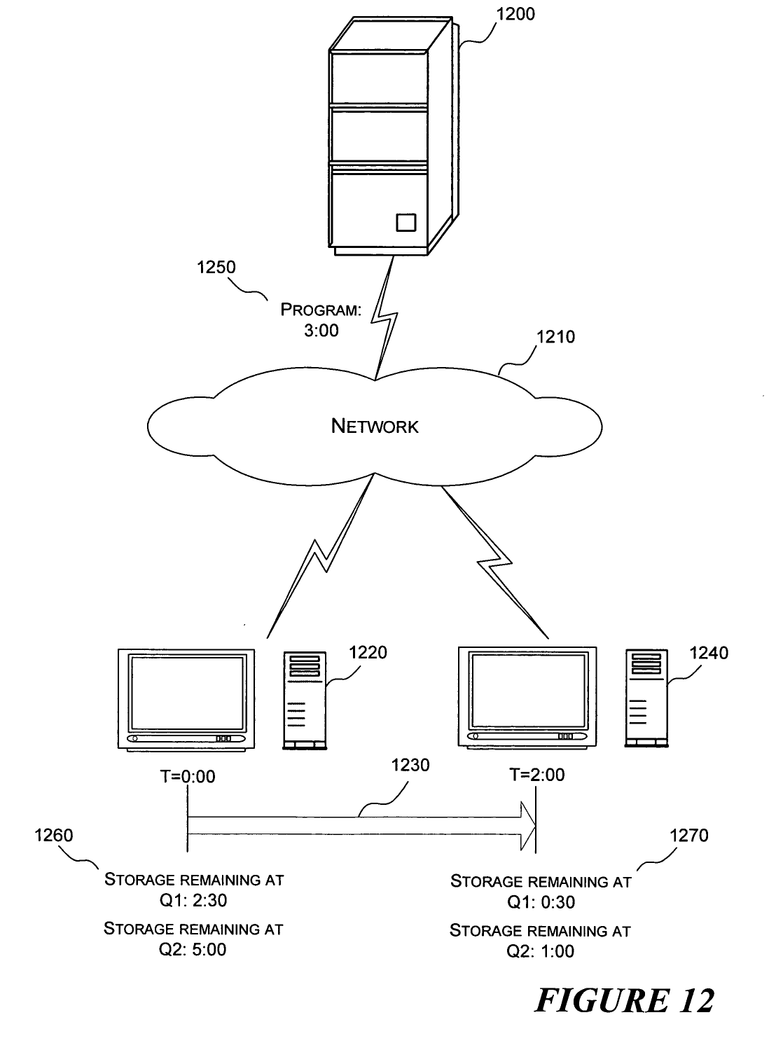

To illustrate time-dependent access level shifting, FIG. 12 shows an example of a network including a sending system 1200 communicating media content via a network 1210 to a personal computer 1220, acting as a digital video recorder, at time T=0:00 on a timeline 1230, and continuing to send media content to the same personal computer at time T=2:00, represented as personal computer 1240. The media content is a program 1250 that is 3:00 hours in length. The storage remaining at time T=0:00 1260 is 2:30 at a first access level Q1, and 5:00 at a second access level Q2. It is assumed that the user elected to record the program 1250 at Q1, a higher access level, and the personal computer 1220 will attempt honor that selection. However, to prevent the user from losing the end of the program 1250, the personal computer is equipped to perform “disk squeezing,” by automatically shifting to a reduced second access level Q2 as needed to “squeeze” the program onto the disk. Alternatively, if the user desires to retain access level Q1 for the whole program, the receiving system may retroactively perform “disk squeezing” of some older stored programs to make room for the new program to be stored at Q1.

In the example of FIG. 12, it is assumed that the personal computer 1220 at time T=0:00 records the media content at higher access level Q1. However, upon reaching a threshold that is automatically determined or manually predetermined, the access level being used by personal computer 1240 in the recording is reduced. For example, the access level is reduced at time T=2:00 to access level Q2. As previously described, the receiving system can reduce the access level by reducing the number of packettes accessed.

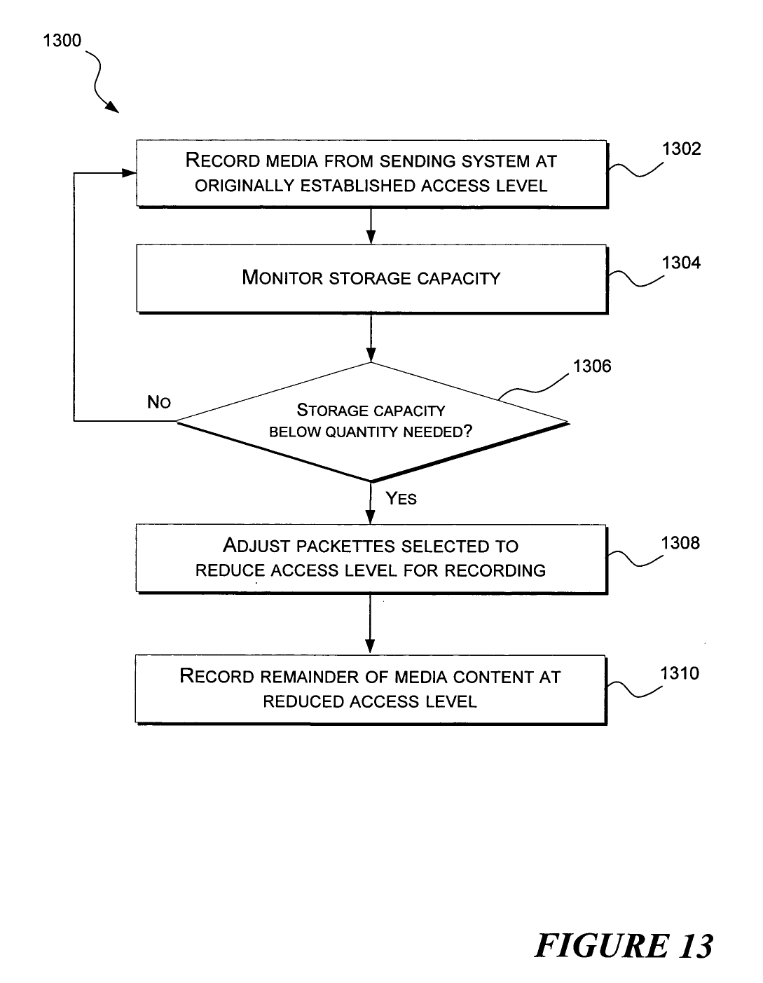

FIG. 13 is a flow diagram of a process 1300 employed in recording, and potentially reducing the storage size of a program by truncating data used to support higher access levels. At 1302, the media content received from the sending system is recorded at an originally established access level. At 1304, the remaining storage capacity of the receiving system is monitored. At 1306, it is determined if the storage capacity will fall short of the quantity needed to record the media content. If not, the process 1300 loops to 1302 to continue recording the media content at the originally established access level.

On the other hand, if it is determined at 1306 that the storage capacity will be insufficient at the current access level, at 1308, the number of packettes accessed is reduced to change the access level used in recording the media content. At 1310, the remainder of the media content is recorded at the reduced access level.

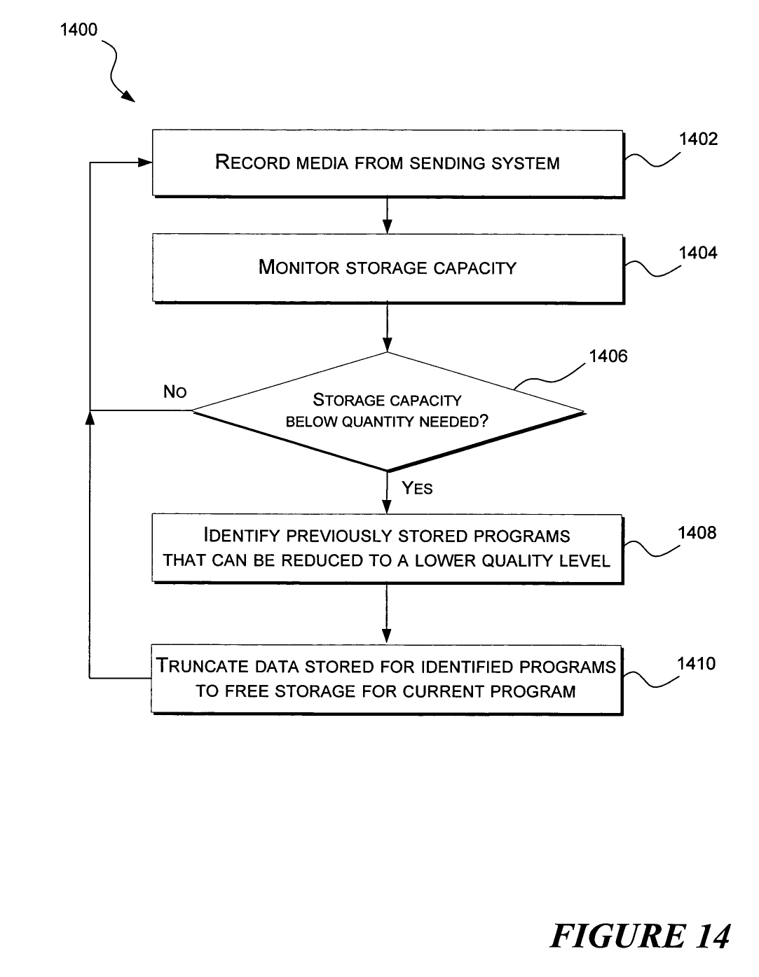

FIG. 14 is a flow diagram of a process 1400 employed in recording, and as needed, reducing the access levels used in storing previously-recorded programs to accommodate a newly recorded program. Storage space can be freed by truncating data used to support the access levels originally used in storing the previously-recorded programs, making that storage available for new programs. At 1402, the media content received from the sending system is recorded at an established access level. At 1404, the remaining storage capacity of the receiving system is monitored. At 1406, it is determined if the storage capacity will fall short of the quantity needed to record the media content. If not, the process 1400 loops to 1402 to continue recording the media content.

On the other hand, if it is determined at 1406 that the storage capacity will be insufficient, at 1408, previously-recorded programs that can be reduced to lower access levels are identified. A number of criteria can be established to determine which programs can be permissibly reduced in access level. For example, programs that have already been viewed or that are flagged as having low importance may be identified for data truncation. At 1410, the identified programs are condensed in size by re-storing the programs at reduced access levels. The process 1400 then loops to 1402 to continue recording the new program in the storage space freed by reducing the storage space consumed by the previously-recorded programs.

These are just some of the applications enabled by an architecture providing adaptive access to media content. Many other applications are similarly supported. To cite one additional example, an embodiment of the architecture supports incremental streaming and enhancement of stored media content. Taking the example of FIG. 12, if media content was recorded at a reduced access level for the last hour of the program, the user may wish to free storage and re-record the last hour of the media content at a higher access level for quality consistency. In this case, because packettes are stored to provide access at the lower access level, additional packettes will need to be acquired to supplement the already stored packettes, instead of the entire codestream needing to be re-sent and re-recorded.

Computing System for Implementing Exemplary Embodiments

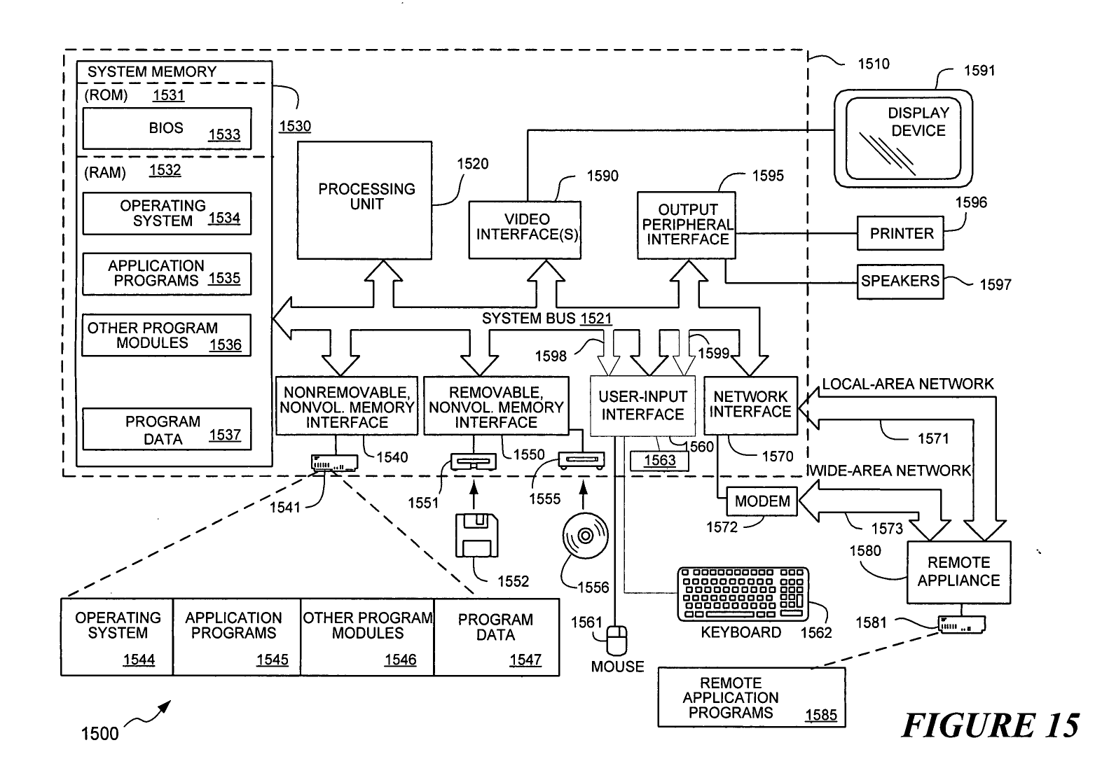

FIG. 15 illustrates an exemplary computing system 1500 for implementing embodiments of an architecture supporting adaptive access to scalable codestreams. The computing system 1500 is only one example of a suitable operating environment and is not intended to suggest any limitation as to the scope of use or functionality of exemplary embodiments of an architecture supporting adaptive access to scalable codestreams or other embodiments. Neither should the computing system 1500 be interpreted as having any dependency or requirement relating to any one or combination of components illustrated in the exemplary computing system 1500.

An architecture supporting adaptive access to scalable codestreams may be described in the general context of computer-executable instructions, such as program modules, being executed on computing system 1500. Generally, program modules include routines, programs, objects, components, data structures, etc., that perform particular tasks or implement particular abstract data types. Moreover, those skilled in the art will appreciate that the architecture supporting adaptive access to scalable codestreams may be practiced with a variety of computer-system configurations, including hand-held devices, multiprocessor systems, microprocessor-based or programmable-consumer electronics, minicomputers, mainframe computers, and the like. The architecture supporting adaptive access to scalable codestreams may also be practiced in distributed-computing environments where tasks are performed by remote-processing devices that are linked through a communications network. In a distributed-computing environment, program modules may be located in both local and remote computer-storage media including memory-storage devices.

With reference to FIG. 15, an exemplary computing system 1500 for implementing the architecture supporting adaptive access to scalable codestreams includes a computer 1510 including a processing unit 1520, a system memory 1530, and a system bus 1521 that couples various system components including the system memory 1530 to the processing unit 1520.

Computer 1510 typically includes a variety of computer-readable media. By way of example, and not limitation, computer-readable media may comprise computer-storage media and communication media. Examples of computer-storage media include, but are not limited to, Random Access Memory (RAM); Read Only Memory (ROM); Electronically Erasable Programmable Read Only Memory (EEPROM); flash memory or other memory technology; CD ROM, digital versatile discs (DVD) or other optical or holographic disc storage; magnetic cassettes, magnetic tape, magnetic disk storage or other magnetic storage devices; or any other medium that can be used to store desired information and be accessed by computer 1510. The system memory 1530 includes computer-storage media in the form of volatile and/or nonvolatile memory such as ROM 1531 and RAM 1532. A Basic Input/Output System 1533 (BIOS), containing the basic routines that help to transfer information between elements within computer 1510 (such as during start-up) is typically stored in ROM 1531. RAM 1532 typically contains data and/or program modules that are immediately accessible to and/or presently being operated on by processing unit 1520. By way of example, and not limitation, FIG. 15 illustrates operating system 1534, application programs 1535, other program modules 1536, and program data 1537.

The computer 1510 may also include other removable/nonremovable, volatile/nonvolatile computer-storage media. By way of example only, FIG. 15 illustrates a hard disk drive 1541 that reads from or writes to nonremovable, nonvolatile magnetic media, a magnetic disk drive 1551 that reads from or writes to a removable, nonvolatile magnetic disk 1552, and an optical-disc drive 1555 that reads from or writes to a removable, nonvolatile optical disc 1556 such as a CD-ROM or other optical media. Other removable/nonremovable, volatile/nonvolatile computer-storage media that can be used in the exemplary operating environment include, but are not limited to, magnetic tape cassettes, flash memory units, digital versatile discs, digital video tape, solid state RAM, solid state ROM, and the like. The hard disk drive 1541 is typically connected to the system bus 1521 through a nonremovable memory interface such as interface 1540. Magnetic disk drive 1551 and optical dick drive 1555 are typically connected to the system bus 1521 by a removable memory interface, such as interface 1550.

The drives and their associated computer-storage media discussed above and illustrated in FIG. 15 provide storage of computer-readable instructions, data structures, program modules and other data for computer 1510. For example, hard disk drive 1541 is illustrated as storing operating system 1544, application programs 1545, other program modules 1546, and program data 1547. Note that these components can either be the same as or different from operating system 1534, application programs 1535, other program modules 1536, and program data 1537. Typically, the operating system, application programs, and the like that are stored in RAM are portions of the corresponding systems, programs, or data read from hard disk drive 1541, the portions varying in size and scope depending on the functions desired. Operating system 1544, application programs 1545, other program modules 1546, and program data 1547 are given different numbers here to illustrate that, at a minimum, they can be different copies. A user may enter commands and information into the computer 1510 through input devices such as a keyboard 1562; pointing device 1561, commonly referred to as a mouse, trackball or touch pad; a wireless-input-reception component 1563; or a wireless source such as a remote control. Other input devices (not shown) may include a microphone, joystick, game pad, satellite dish, scanner, or the like. These and other input devices are often connected to the processing unit 1520 through a user-input interface 1560 that is coupled to the system bus 1521 but may be connected by other interface and bus structures, such as a parallel port, game port, IEEE 1394 port, or a universal serial bus (USB) 1598, or infrared (IR) bus 1599. As previously mentioned, input/output functions can be facilitated in a distributed manner via a communications network.

A display device 1591 is also connected to the system bus 1521 via an interface, such as a video interface 1590. Display device 1591 can be any device to display the output of computer 1510 not limited to a monitor, an LCD screen, a TFT screen, a flat-panel display, a conventional television, or screen projector. In addition to the display device 1591, computers may also include other peripheral output devices such as speakers 1597 and printer 1596, which may be connected through an output peripheral interface 1595.

The computer 1510 will operate in a networked environment using logical connections to one or more remote computers, such as a remote computer 1580. The remote computer 1580 may be a personal computer, and typically includes many or all of the elements described above relative to the computer 1510, although only a memory storage device 1581 has been illustrated in FIG. 15. The logical connections depicted in FIG. 15 include a local-area network (LAN) 1571 and a wide-area network (WAN) 1573 but may also include other networks, such as connections to a metropolitan-area network (MAN), intranet, or the Internet.

When used in a LAN networking environment, the computer 1510 is connected to the LAN 1571 through a network interface or adapter 1570. When used in a WAN networking environment, the computer 1510 typically includes a modem 1572 or other means for establishing communications over the WAN 1573, such as the Internet. The modem 1572, which may be internal or external, may be connected to the system bus 1521 via the network interface 1570, or other appropriate mechanism. Modem 1572 could be a cable modem, DSL modem, or other broadband device. In a networked environment, program modules depicted relative to the computer 1510, or portions thereof, may be stored in the remote memory storage device. By way of example, and not limitation, FIG. 15 illustrates remote application programs 1585 as residing on memory device 1581. It will be appreciated that the network connections shown are exemplary, and other means of establishing a communications link between the computers may be used.

Although many other internal components of the computer 1510 are not shown, those of ordinary skill in the art will appreciate that such components and the interconnections are well-known. For example, including various expansion cards such as television-tuner cards and network-interface cards within a computer 1510 is conventional. Accordingly, additional details concerning the internal construction of the computer 1510 need not be disclosed in describing exemplary embodiments of the key management process.

When the computer 1510 is turned on or reset, the BIOS 1533, which is stored in ROM 1531, instructs the processing unit 1520 to load the operating system, or necessary portion thereof, from the hard disk drive 1541 into the RAM 1532. Once the copied portion of the operating system, designated as operating system 1544, is loaded into RAM 1532, the processing unit 1520 executes the operating system code and causes the visual elements associated with the user interface of the operating system 1534 to be displayed on the display device 1591. Typically, when an application program 1545 is opened by a user, the program code and relevant data are read from the hard disk drive 1541 and the necessary portions are copied into RAM 1532, the copied portion represented herein by reference numeral 1535.

### CONCLUSION

Although exemplary embodiments have been described in language specific to structural features and/or methodological acts, it is to be understood that the appended claims are not necessarily limited to the specific features or acts previously described. Rather, the specific features and acts are disclosed as exemplary embodiments.

1. A method implementable by at least one computing system for providing access to a scalable codestream, the method comprising:
identifying data including at least a portion of a full data set included in the scalable codestream to present the scalable codestream at a selected access level;
collecting the data from the scalable codestream into a plurality of packettes, each of the packettes including at least one of a plurality of minimum coding units of the data such that a receiving system to which the plurality of packettes are provided can effect a change in the selected access level by adapting a number of packettes accessed; and
in response to a message from the receiving system seeking a change in the selected access level, adapting a number of packettes provided to the receiving system.

2. A method of claim 1, wherein the minimum coding units included in the packettes represent at least a portion of a scalable segment relating to a plurality of access levels supported by the scalable codestream.

3. A method of claim 1, wherein each of the packettes includes:
a content portion including the at least one of the plurality of minimum coding units; and
a header portion including a description of the at least one of the plurality of the minimum coding units included in the content portion.

4. A method of claim 1, further comprising inserting a peer layer among layers of a computer networking protocol at a point between an application layer operable to support user applications and a transport layer operable to one of collect the packettes provided into transport packets and unpacking the packettes provided from the transport packets.

5. A method of claim 4, wherein the peer layer supports at least one application program interface configured to receive commands from an application executing on the receiving system allowing the application to initiate commands to effect a change in the selected level of access, the commands being entered by a user and automatically generated by the receiving system.

6. A method of claim 1, further comprising the receiving system locally reducing the selected access level by allowing the receiving system to select a portion of the plurality of packettes.

7. A method of claim 1, further comprising the receiving system requesting an increase to the selected access level by requesting an increase in the number of packettes provided to the receiving system.

8. A method of claim 1, further comprising the receiving system providing status information regarding the receiving system including at least one of processing capability, bandwidth availability, and quality of service.

9. A method of claim 1, wherein the selected access level is determined by one of:
a default setting;
selection by a system providing the plurality of the packettes; and
at least one receiving system.

10. A computer-medium having computer-useable instructions embodied thereon for executing the method of claim 1.

11. A method implementable by at least one computing system for processing content from a scalable codestream, the method comprising:
identifying a selected access level at which to access the content of the scalable codestream;
receiving a plurality of packettes to provide access to the content of the scalable codestream at the selected access level, each of the packettes including at least one of a plurality of minimum coding units of data drawn from the scalable codestream; and
effecting a change in the selected access level by adapting a number of packettes accessed; and
being able to communicate to a source of the plurality of the packettes a change in the selected level of access involving a change in a number of packettes provided to the receiving system.

12. A method of claim 11, wherein each of the packettes includes:
a content portion including the at least one of the plurality of minimum coding units; and
a header portion including a description of the at least one of the plurality of the minimum coding units included in the content portion.

13. A method of claim 11, further comprising inserting a peer layer among layers of a computer networking protocol at a point between an application layer operable to support user applications and a transport layer operable to retrieve the packettes from transport packets in which the packettes were provided.

14. A method of claim 13, wherein the peer layer supports at least one application program interface configured to receive commands from an application executing on the receiving system allowing the application to initiate commands to effect a change in the selected level of access, the commands being entered by a user and automatically generated by the receiving system.

15. A method of claim 11, further comprising requesting an change to the selected access level by requesting from a system providing the plurality of packettes a change in the number of packettes provided to the receiving system.

16. A method of claim 11, further comprising the receiving system providing status information to the source including at least one of processing capability, bandwidth availability, and quality of service.

17. A method of claim 11, further comprising:
redirecting the plurality of packettes to at least one different receiving system;
adapting the selected access level according to the capabilities of the different receiving device by at least one of:
effecting a change in the selected access level by adapting a number of packettes accessed by the different receiving system; and
communicating to the source of the packettes a change in the selected level of access involving a change in the number of packettes provided to the receiving system.

18. A method of claim 11, further comprising an additional receiving system receiving the plurality of packettes, the additional receiving system being able to effect a change in the selected access level by adapting the number of packettes accessed by the different receiving system without changing the level of access of the receiving system.

19. A computer-medium having computer-useable instructions embodied thereon for executing the method of claim 11.

20. A system for participating in an exchange of data providing access to content of a scalable codestream, the system including at least one of a sending system and a receiving system, including:
a peering system configured to at least one of receive a plurality of packettes to allow access to the content of the scalable codestream and to form a plurality of packettes to provide access to the content of the scalable codestream;
a kernel for one of causing the plurality of packettes to be transmitted to a second system and to receive the plurality of packettes from the second system;
a network engine configured to monitor a status of at least one of a first system and the second system, and a network joining the first system and second system; and
a control system operably coupled with the peering system, the kernel, and the network engine and operable to change:
a number of packettes provided to the second system; and
a number of packettes accessed by the second system.
